(19) United States
(12) Patent Application Publication
(10) Pub. No.: US 2024/0160670 A1
(43) Pub. Date: May 16, 2024

(54) USER-SPECIFIC WORKFLOW FOR TRACKING DOCUMENTS AT SCALE

(71) Applicant: QUORUM, Washington DC, MD (US)

(72) Inventors: Sean McGowan, Arlington, VA (US); Marty Heavey, San Francisco, CA (US); Jonathan Marks, Boulder, CO (US)

(21) Appl. No.: 17/988,648

(22) Filed: Nov. 16, 2022

(51) Int. Cl. G06F 16/9038; G06F 16/9035

(52) U.S. Cl. CPC G06F 16/9038; G06F 16/9035

(57) ABSTRACT

An apparatus may receive, through a user interface, an indication for one or more filters that provide at least one of user-specific search results or organization-specific search results in response to a search query. The one or more filters may be applied to an initial set of data associated with execution of the search query. The apparatus may receive, through the user interface, user input for the execution of the search query and for generation of the initial set of data. The apparatus may filter the initial set of data using the one or more filters indicated via the user interface and output, in response to the execution of the search query, the at least one of the user-specific search results or the organization-specific search results filtered based on the one or more filters.

### TECHNICAL FIELD

The present disclosure relates generally to database searching, and more particularly, to user-specific workflows for tracking new and changing documents of many types at scale.

### BACKGROUND

Many organizations have the need to track information that impacts their interests, such as mentions of their organization or their issues in the news, on social media, in pending legislation or regulation, etc. Doing so is typically performed through a software-mediated system of some kind, where a user might set up a search in a news database, for example, and receive an alert whenever a given document (e.g., a news article, a social media post, a pending piece of legislation, a pending regulation, etc.) in that database is created that matches that particular search. Keeping track of many different searches with many results across many individuals within a given organization, however, is very work-intensive, and often results in multiple individuals reviewing the same information or a single individual reviewing the same documents multiple times across many searches.

One way of reducing duplicative efforts is to provide an interface where individuals can easily create “search term lists” of documents that result from a particular set of database filters and then automating the reasons by which a given document might be added or removed from those search term lists, such as if, for example, another person on their team has already reviewed a document, they might desire that it automatically be removed from all other individuals' search term lists in that organization.

As another example, an organization might add or eliminate search terms from a search term list based on a stance (e.g., supports or opposes) that one or more users within the organization have with respect to a particular bill/document stored in the database. For example, if a user likes/dislikes a particular bill, or regards the particular bill as unimportant, the bill can be indicated accordingly on a tracking board or removed from the tracking board altogether from either their search term lists or the other individuals' search term lists. While a bill/document might get removed from the tracking board based on a single criterion, different users within the organization might filter the documents of the database in different ways, which might generate inconsistencies in the output search results and/or inconsistencies in the removal of bills/documents from the tracking board. Accordingly, there is a need for techniques that improve a workflow of the organization.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method includes receiving, through a user interface, an indication for one or more filters that provide at least one of user-specific search results or organization-specific search results in response to a search query, the one or more filters applied to an initial set of data associated with execution of the search query; receiving, through the user interface, user input for the execution of the search query and for generation of the initial set of data; filtering the initial set of data using the one or more filters indicated via the user interface; and outputting, in response to the execution of the search query, the at least one of the user-specific search results or the organization-specific search results filtered based on the one or more filters.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### DESCRIPTION OF THE DRAWINGS

FIG. 1 is a diagram illustrating an example content generation system.

FIG. 2 is a diagram illustrating a mapping from a plurality of tables associated with different data sets to a combined table.

FIG. 3 is a diagram that illustrates recent information for a user being generated after a most recent indexing update to a combined table.

FIG. 4 is a diagram that illustrates layers and interfaces for a server and a client.

FIG. 5 is a diagram illustrating an information workflow.

FIG. 6 is a diagram that illustrates tracking boards associated with a plurality of search results.

FIG. 7 is a flowchart of a method of outputting user-specific search results.

FIG. 8 is a high-level illustration of an exemplary computing device that can be used in accordance with the systems and methodologies disclosed herein.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects are presented with reference to various apparatus and methods. These apparatus and methods are described in the following detailed description and illustrated in the accompanying drawings by various blocks, components, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip, baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

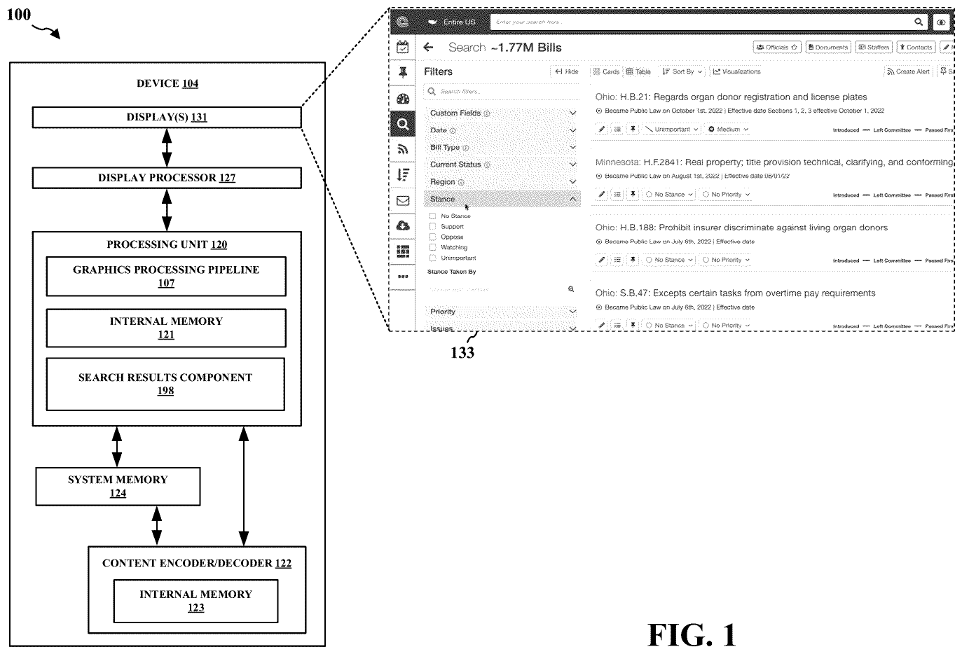

FIG. 1 is a block diagram that illustrates an example content generation system 100. The content generation system 100 includes a device 104 that has one or more components or circuits for performing various functions described herein. The device 104 may include one or more displays 131, a display processor 127, a processing unit 120, a system memory 124, a content encoder/decoder 122, etc. Display(s) 131 may also be referred to herein as one or more displays 131. In some examples, graphics processing results/graphical content associated with an output of a search engine may be displayed through a user interface (UI) 133 on the display(s) 131. In other examples, the graphical processing results/graphical content may be transferred to another device for display, which may be referred to as split-rendering.

The processing unit 120 may include a graphics processing pipeline 107 and an internal memory 121. The processing unit 120 may be configured to perform graphics processing using the graphics processing pipeline 107. The processing unit 120 may also generate the graphical content displayed through the UI 133. The processing unit 120 further includes a search results component 198, as will be discussed in further detail below, for performing various aspects and functionality described herein.

The display processor 127 may be configured to perform one or more display processing techniques on one or more frames/graphical content generated by the processing unit 120 before the frames/graphical content is displayed through the UI 133 on the one or more displays 131. While the example content generation system 100 illustrates a display processor 127, it should be understood that the display processor 127 is one example of a processor that can perform the functions descried herein and that other types of processors, controllers, etc., may be used as substitute for the display processor 127. The one or more displays 131 may be configured to display or otherwise present graphical content processed/output by the display processor 127. In some examples, the one or more displays 131 may include a liquid crystal display (LCD), a plasma display, an organic light emitting diode (OLED) display, a projection display device, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 includes the internal memory 121. The content encoder/decoder 122 may also include an internal memory 123. The processing unit 120 and the content encoder/decoder 122 may be communicatively coupled to the system memory 124 over a bus. In some examples, the processing unit 120 and the content encoder/decoder 122 may be communicatively coupled to the internal memories 121/123 over the bus or via a different connection. The content encoder/decoder 122 may be configured to receive graphical content from any source, such as the system memory 124 and/or the processing unit 120, and encode or decode the graphical content. In some examples, the graphical content may be in the form of encoded or decoded pixel data. The system memory 124 may be configured to store the graphical content in an encoded or decoded form.

The internal memories 121/123 and/or the system memory 124 may include one or more volatile or non-volatile memories or storage devices. In some examples, internal memories 121/123 or the system memory 124 may include RAM, static random access memory (SRAM), dynamic random access memory (DRAM), erasable programmable ROM (EPROM), EEPROM, flash memory, a magnetic data media, optical storage media, or any other type of memory. The internal memories 121/123 or the system memory 124 may be a non-transitory storage medium according to some examples. The term “non-transitory” may indicate that the storage medium is not embodied in a carrier wave or a propagated signal. However, the term “non-transitory” should not be interpreted to mean that the internal memories 121/123 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), or any other processing unit that may be configured to perform graphics processing. The content encoder/decoder 122 may be any processor configured to perform content encoding and content decoding. In some examples, the processing unit 120 and/or the content encoder/decoder 122 may be integrated into a motherboard of the device 104. The processing unit 120 may be present on a graphics card that is installed in a port of the motherboard of the device 104, or may be otherwise incorporated within a peripheral device configured to interoperate with the device 104. The processing unit 120 and/or the content encoder/decoder 122 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combination thereof. If the techniques are implemented partially in software, the processing unit 120 and/or the content encoder/decoder 122 may store instructions for the software in a suitable, non-transitory computer-readable storage medium (e.g., memory) and may execute the instructions in hardware using one or more processors to perform the techniques of this disclosure. Any of the foregoing, including hardware, software, a combination of hardware and software, etc., may be considered to be one or more processors.

In certain aspects, the processing unit 120 (e.g., GPU, CPU, etc.) may include a search results component 198, which may include software, hardware, or a combination thereof configured to: receive, through a user interface, an indication for one or more filters that provide at least one of user-specific search results or organization-specific search results in response to a search query, the one or more filters applied to an initial set of data associated with execution of the search query; receive, through the user interface, user input for the execution of the search query and for generation of the initial set of data; filter the initial set of data using the one or more filters indicated via the user interface; and output, in response to the execution of the search query, the at least one of the user-specific search results or the organization-specific search results filtered based on the one or more filters. Although the following description may be focused on executing searches, the concepts described herein may be applicable to other similar processing techniques.

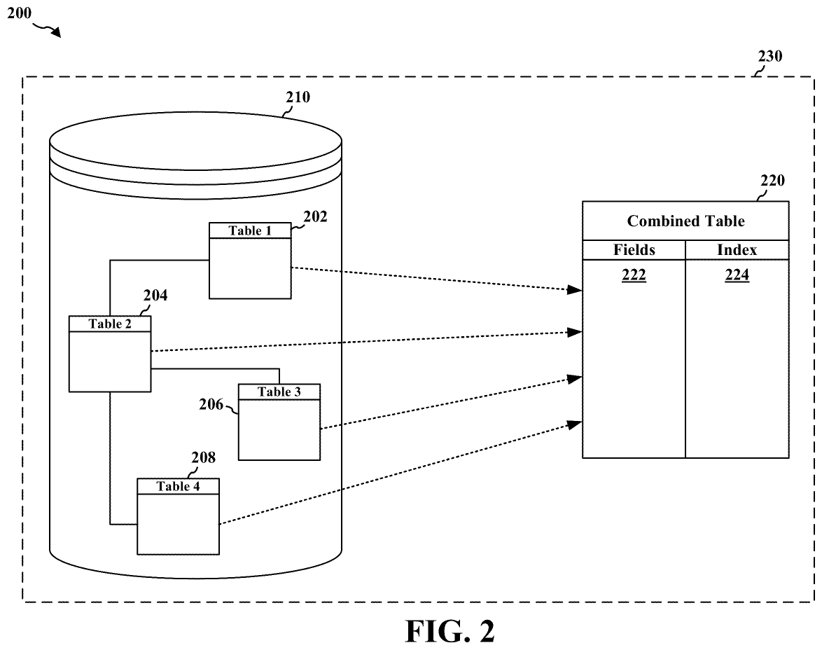

FIG. 2 is a diagram 200 illustrating a mapping from a plurality of tables 202-208 associated with different data sets to a combined table 220. Input/output (I/O) load reductions based on full-text search (FTS) indices may increase a search speed of documents/information stored in a database 210 and improve a user experience. For example, removing FTS indices may reduce the I/O load associated with FTS procedures by 20-30%, which may increase the document search speed by a factor of 10 and increase the update/insert (i.e., “upsert”) speed by a factor of 100. More accurate document search results may also be provided based on eliminating phrase searches associated with FTS processes.

In examples, rather than joining different data sets together, such as table 1 202, table 2 204, table 3 206, and table 4 208, through various logical connections in a relational database 210 and searching the different data sets during a same procedure, information from separate tables 202-208 within the database 210 may be combined and stored in a same data set as a combined table 220 to perform a search across both common data, such as general document information applicable to multiple users (e.g., title, document number, etc.), as well as user-specific data, such as a “stance” that the user has (e.g., likes or dislikes) for particular documents within the database 210.

A search of the combined/stored data associated with a single/combined table 220 may be executed more quickly than a search of data stored in the relational database 210 that might include the various logical connections between the multiple data sets/tables 202-208. The data mapped to the combined table 220 from the different data sets of the relational database 210 may be searched based on a single index 224. Indexing the information in the data set may include changing a search destination to indicate a different destination than FTS indices. The index 224 may be sharded into different logical segments for different types of data. For example, documents in the data set may be of different types, including “documents” as an alias for feature-based document indices, a separate shard for each of news articles, social media posts, legislation, or other types of documents, etc. However, sharding techniques may be less applicable in cases where new types of documents are being generated and added to the data set. Therefore, indexing procedures may be performed based on a retention period or performed in a manner that combines newly generated documents with other document types. The index 224 could be updated daily, monthly, etc., depending on a size of the data set, where each updated index 224 might include 3-5 shards. Each shard might be further limited in size to 10-50 gigabytes (GB).

FTS searches may be performed on data stored in the relational database 210. For example, if a user performs a search for a legislative bill in the relational database 210, metadata might be generated that indicates whether the user views the legislative bill favorably (e.g., likes or dislikes the bill), whether the legislative bill is associated with a particular issue of interest to the user, whether the user views the legislative bill as important, etc. The metadata might also be indicative of a public official that sponsored the legislative bill and/or a political party from which the legislative bill originated. Different fields of information may be stored in the different tables 202-208 that are logically connected for searching the data based on a relational model. The information in the different tables 202-208 may be filtered based on an input to generate an output indicative of a particular field, but processing speeds may be decreased as a result of having to index across the various logical connections to the different data sets/tables 202-208.

Unlike relational database searching, which may be based on searching multiple tables 202-208 that include the different data sets to generate the output, a single index 224 with increased robustness may be used to search a same data set/table 220. The indexing structure for the search may allow the data set to be searched more efficiently given that a non-relational model does not rely on logical interconnections between many different tables/data sets. Database fields for each document/table 202-208 stored in the database 210 may be mapped to search fields 222 for performing the search. Example database fields might include “created” or “updated” fields and a corresponding example database field type might include a “date” field type. In another example, the database field might be a “position in record” and the corresponding database field type might be an “interger” field, which may be mapped to an “int” search type. Many other database fields/types and search fields/types are contemplated by this disclosure. Single index searches may also offer backward compatibility in terms of searching, filtering, functionality, etc.

A database 230 that includes the combined table 220 for the search may be updated based on a cron or any other mechanism for processing updates to datasets, such as reading items from a queue. The cron may be executed at periodic intervals to check for and store new/updated documents in the database 230 for indexing. In some examples, other crons may be executed at the same or different periodic intervals to delete documents from the database 230. For example, a cron may be executed daily or monthly to remove documents from the database 230 that have become stale. When the database 230 includes a large number of documents, indexing all the documents during a same procedure might decrease a speed of the search. Hence, a plurality of crons may be executed to store/update various documents by type, region, etc.

Denormalization techniques may be implemented to increase performance based on copying information from multiple tables 202-208 into the combined table 220 used for the search. Demormaliztion refers to the process of adding redundant copies of data or grouped data to a data set to improve a read performance of the database 230, but which may come at a cost to the write performance of the database 230. In an example, a legislative bill might include information that is common for each user that downloads the legislative bill (e.g., the title, the bill number, etc.). Thus, storing N copies of the legislative bill for each user in the database 230 may result in decreased performance, particularly when certain information is redundant/common to different user searches. Accordingly, indexing techniques may be based on aggregating data from multiple users searches and denormalizing the data to improve the search speed. Aggregation and denormalization may be performed for each data type of a plurality of data types included in the different tables 202-208 and/or may be performed for arbitrary data types. The data may be stored in the combined table 220 that may be searched by one or more users. When the data is searched, the data may be reduced to reveal only information that a searching user is authorized to view (e.g., based on filtering).

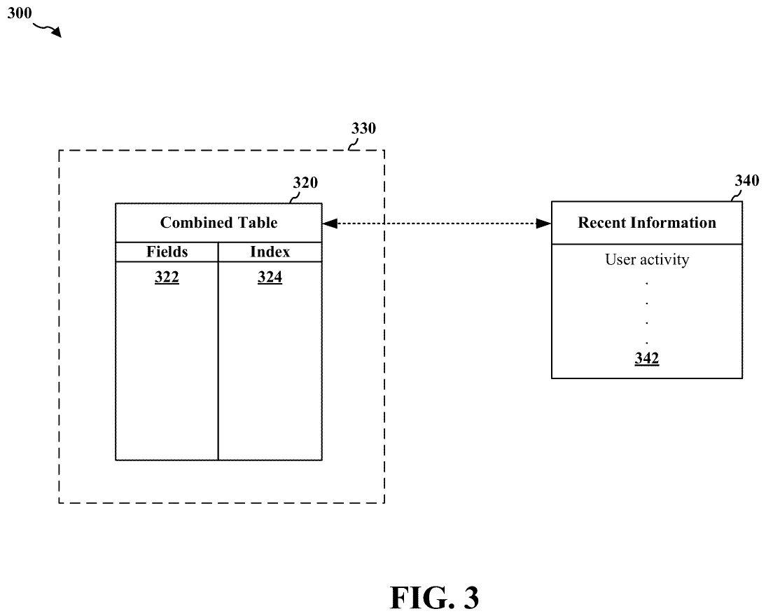

FIG. 3 is a diagram 300 that illustrates recent information 340 for a user being generated after a most recent indexing update to a combined table 320. Based on a mapping from a relational database to the fields 322 of the combined table 320, user-specific information/inputs may be analyzed for changes that have occurred since the index 324 was last updated. If user information has changed, the data set may be re-indexed/resaved based on the recent changes at a next update time for the index 324. Logical connections between different tables of the relational database may also be updated periodically prior to performing mappings of the data to the combined table 330 for indexing. The index 324 may be used for one or more search queries of one or more users. Some data structures may or may not include both relational and non-relational databases. For example, the database 330 illustrated in FIG. 3 might be a standalone database that includes the combined table 320, whereas the database 230 illustrated in FIG. 2 might include both a non-relational data set (e.g., the combined table 220) and a relational data set (e.g., the different tables 202-208).

Results from the denormalized database 330 may be combined with the recent information 340 based on recent user activity 342 to increase an accuracy of the output for a search query. An output generated based on both the denormalized data and the recent information 340 may be compared to a relational database output to determine whether the outputs are the same. If so, the relational database output/model may be used. Otherwise, the combined information output is used. A join that occurs in the relational database may increase the speed of the search. In other databases, where a FTS would have been slow using a relational database and/or filtering, the combined table 320 may be used to increase the speed, given that there may not be a difference in the output results.

As the index 324 may be updated on a periodic basis, a delay period may occur where new information has become available but the index 324 has not yet been updated based on the new information. Thus, if a user executes a search (e.g., indicating an assignment and/or a stance for a search), the generated results might be more accurate if the output also accounts for the recent information 340/user activity 342 that has not yet been considered for indexing in the combined table 320. Since denormalization might not be a continuous procedure, or even a frequently procedure, due to an increased amount of time associated with updating large indexes (that may include millions of links), a tradeoff may be observed between updating the index 324 on a more frequent basis and being able to search/retrieve information more quickly.

Single index searching may be extended to data associated with recent user activity 342 (e.g., caching user-provided metadata alongside non-user-provided metadata). For example, a user may select a first legislative bill of interest to the user. A few second later the user may execute a search for other bills of interest to the user, which might include a match to a particular search term. Updating a common/global index 324, which may be used by multiple users, to reflect recent user activity 342 may be a relatively slow procedure that could impact a speed of the search results for a query. Additionally, cached information may be outdated, which may lead to less accurate search results.

Accordingly, data associated with recent inputs from a user might not available to contribute to search results until after the index 324 is refreshed/updated at a periodic/predefined interval. Thus, when a user performs a search, a separate query may be executed to search for recent information 340/inputs (e.g., that may be less than 15 minutes old) corresponding to a search type of the search being performed. For instance, if the search type corresponds to a “stance” on a legislative bill, such as the user views the bill favorably, the separate query may be executed to search for other stances that the user has recently input (e.g., within the last 15 minutes). In an example, a user might indicate that legislative bill X is of interest to the user. Further, a relational database might indicate which stance(s) have occurred over a recent timeframe (e.g., last 15 minutes), so that the stances may be considered along with the combined table 320 to generate an output. That is, the separate query executed based on a user search that occurs 30 seconds after the index 324 is updated may allow the output results to be based on the stance(s) associated with the recent user activity 342.

In another example, a search may be executed for bills that reference X along with an additional query parameter. Some outputs may provide outdated results (e.g., by a few minutes), if the outputs do not account for recent inputs from the user. The bills that reference X might not change. However, the additional query parameter might be outdated (e.g., by a few minutes) as a result of delays in updating the index 324. When a search is performed by the user, the bills that reference X may be queried along with the additional query parameter. To reduce a possibility of having the results be outdated, a relational database is also queried to determine the recent information 340/inputs from the user related to the additional query parameter. As text searching may not be part of the separate query associated with the user activity 342, the search may be performed relatively quickly.

For execution of a search for the bills that reference X along with the additional query parameter, documents determined to be associated with the recent information 340/inputs may be used to generate the results. In examples, such documents may be further searched based on text conditions. Some results associated with the recent information 340 may also be excluded, if the user activity 342 indicates that the results do not satisfy the additional query parameter. The search for the recent information 340 may be time bounded based on a periodic interval for updating the index 324. For example, if the index is updated every M minutes, user activity searches of the relational database may be limited to the previous M minutes, or an even shorter time to the last index update.

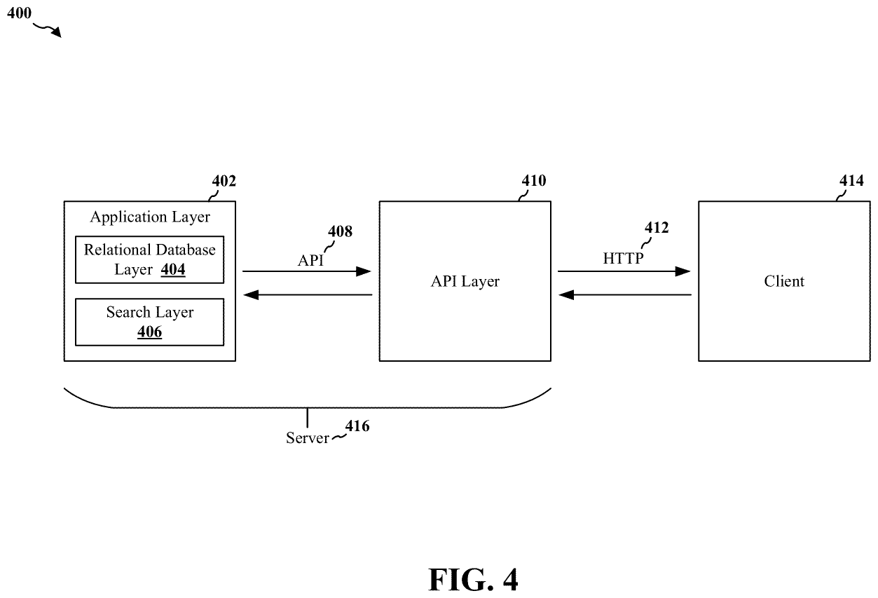

FIG. 4 is a diagram 400 that illustrates layers and interfaces for a server 416 and a client 414. In order to increase security over information that is viewable to specific users at the client 414, a filter may be applied on top of output information from an application layer 402 before the information is received by an application programming interface (API) layer 410 over an API 408. The filter may be user-specific so that a particular user is only able to view the information that the user is authorized to view. The API layer 410 may not have access to the information in a data store (e.g., search documents), and may communicate with the application layer 402 to receive the information. Within the application layer 402, a relational database layer 404 may be in communication with a searching layer 406.

Some user information may be indexed, rather than stored at the searching layer 406. A user may transmit a request from the client 414 to the server 416, such as by hypertext transfer protocol (HTTP) 412, which may indicate a query for the searching layer 406. The query may trigger filtering operations, such as a filter for FTS or query parameters, for displaying information fields to the users via the client 414. The information may be serialized and sent to a front end for the user to view at the client 414.

User identity information might not be the subject of a user query, but the query and the identity of the user may be determined for applying the filter. However, the identity of the user may remain secure based on applying the filter to the search/query, as the information indicated to the application layer 402 over the API 408 is not indicative of the user identity. That is, the information filtered out for the query is not used by the application layer 402 to return information to other users that are also initiating queries on the same data set, which provides a level of information security for the user of the client 414. In particular, user-specific/private information is filtered out, which provides a first layer of security at the client level based on queries not requesting user information and a second layer of security at the application layer 402 based on the filtering.

Searches at the searching layer 406 may be based on predefined search options (e.g., drop-down menus, radio buttons, etc.) and/or based on free text searches (e.g., search bars). Some searches may be executed based on objective criteria, such as titles, labels, etc., while other searches may be executed based on subjective criteria, such as a stance that the user has on a particular document. Hence, some search results may be returned using a snippet engine that indicates highlighted snippets from one or more documents. The snippet engine may determine to highlight snippets based on one or more query parameters used for the search at the searching layer 406.

Fast types of queries may experience a 4 times increase in search speed based on the searching techniques described herein and slower types of queries may experience a 20-40 times increase in search speed based on the searching techniques described herein. Join results may also experience a corresponding increase in speed based on denormalization procedures. Rather than having multiple different tables that are logically connected, denormalization allows the information to be included in a same/combined table, which provides the increase in search speed. A tradeoff between normalization and denormalization is that denormalization provides for faster querying, but may experience a reduction in accuracy, whereas normalization may provide for slower querying, but can produce results with improved accuracy. Thus, the searching techniques described herein may be implemented to balance the tradeoff between search speed and accuracy.

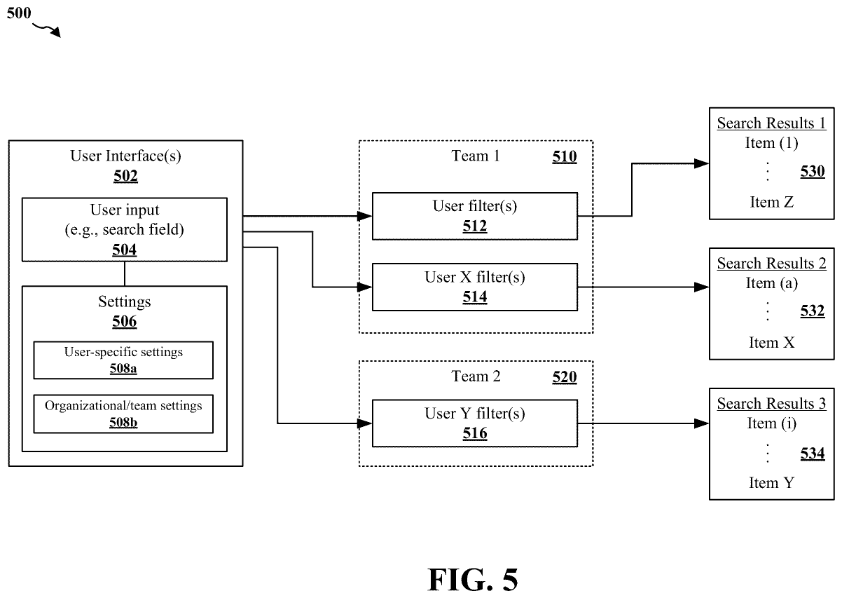

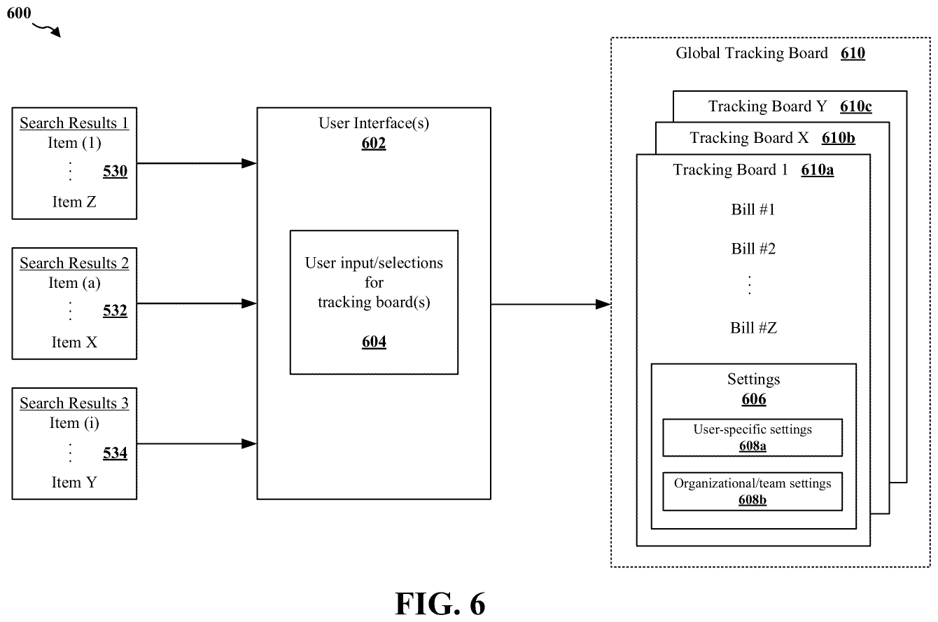

FIG. 5 is a diagram 500 illustrating an information workflow. An organization might add or eliminate search terms from a search term list based on a stance (e.g., supports or opposes) that one or more users within the organization have with respect to a particular bill/document stored in the database. For example, if a user likes/dislikes a particular bill, or regards the particular bill as unimportant, the bill can be flagged accordingly on a tracking board (illustrated in FIG. 6) or removed from the tracking board altogether. While a bill/document might get removed from the tracking board based on a single criterion, different users within the organization might filter 512-516 the documents of the database in different ways, which might generate inconsistencies in the output search results 530-534 and/or inconsistencies in the removal of bills/documents from the tracking board. For instance, a first user might filter 512 the documents based on U.S. states A, B, and C, whereas a second user might filter 514 the document based on U.S. states A, D, and E. Thus, updated functionalities associated with the tracking broad for different filtering combinations might improve a user space and/or a workflow for the organization and/or the one or more users.

The updated functionality might increase an efficiency for which groups/teams 510/520 of users can track large amounts of information from multiple different jurisdictions and/or multiple different types of contacts. In an example, a multinational corporation might be interested in state legislation within in the United States. For instance, the multinational corporation may be a soft drink company that has an interest in a new soda tax that different states or local governments are attempting to pass. If the multinational company takes a stance against the newly proposed soda tax, the company may want to know which jurisdictions/areas that tax is being proposed, so that the company can hire a team of lobbyists to oppose the bill. For example, the company might determine that a best use of resources for the particular situation could be to hire ten state lobbyists and four local lobbyists, where the state lobbyists may be allocated in different ways. Perhaps a first subset of the ten state lobbyists is responsible for three states and also the concept of sugar taxes, a second subset of the ten lobbyists is responsible for six (same or different) states but not responsible for a particular issue area, and a third subset of the ten lobbyists is responsible for other states as well as a shared responsibility for the concept of sugar taxes. Hence, the organization might care about multiple aspects related to different types of soda taxes but allocate the reviewing responsibilities to different teams 510/520 in non-uniform ways.

When executing searches of the database, there are different types of user inputs 504 (e.g., search queries) and different ways that reviewers might be looking through pieces of legislation to find certain information. Even before formal legislation is proposed, public discussions may arise regarding soda taxes, which may be available through meeting agendas, hearing notes, press releases, social media posts, etc., that may enable the company to provide user input 504 via a search field to get a sense of legislative proposals that could be forthcoming. Thus, one or more teams 510/520 of reviewers might have to be able to receive/review hundreds of thousands of documents/information over a short period of time.

Accordingly, the updated functionalities associated with the tracking broad might include user interface(s) 502 where the one or more users can input 504, into a system, particular topics and/or search terms that the company/organization would be interested in. That is, the interface 502 may receive user input 504 that indicates how information should be selected and allocated to one or more different users or teams 510/520 performing the review for the company. The interface 502 may also be used to input search settings 506, such as user-specific settings 508a and/or organizational/team-wide settings 508b for a particular set of information being reviewed/tracked by the one or more different users or teams 510/520.

An individual user may then apply filter(s) 512 that indicate one or more additional layers of automated filtering, such as which U.S. states the individual user wants the output results to relate. The additional layers of automated filtering applied 512 to the search can be different for different users. For instance, if the individual user is one of two users responsible for sugar taxes, the individual user might not care about X, but may care about whether the second user (e.g., user X) has already reviewed a particular piece of legislation that was flagged as being potentially relevant to sugar taxes. Thus, the system may automatically remove search results from the output of the individual (first) user that the second user already reviewed. Applying the additional filtering functionality 512 on top of a search 504 performed by the individual user can allow the output search results 530 to be automatically filtered down in a more efficient manner for the individual user to review. Thus, a first list of search results 530 including item (1) through time Z may be specific to the first user. User X on the same team (e.g., Team 1 510) as the first user can similarly apply user X filter(s) 514 that are specific to user X to generate a second list of search results 532 including item (a) through item X that may be specific to user X. Likewise, a user Y on a different team (e.g., Team 2 520) than the first user can apply user Y filter(s) 516 that are specific to user Y to generate a third list of search results 534 including item (i) through item Y that may be specific to user Y.

A global filter based on the organizational/team settings 508b might only allow bills with certain characteristics (on top of the text of the bill) to be included in the output of a search. A first set of characteristics might be indicative of information that is no longer relevant to the user, and a second set of characteristics might be indicative of other information that is, or has become, relevant to the user. Thus, the settings 508a-508b for the global filters and specific filters 512-516 might have to be harmonized on both an individual level and an organizational level. The user interface 502 is implemented such that each user can input 504 information related to a same topic but receive search results 530-534 that are customized for the user in a specific way. For example, metadata added to individual information items, such as bills, pieces of regulation, documents, etc., allows the information items to be retrieved via an algorithm that outputs the results 530-534 based on a relevancy to a specific user and/or team 510/520.

The user interface 502 provides the functionality for the user to indicate a reason why certain information might be relevant or removed from consideration. Default options might correspond to whether the user has been added to a particular issue, whether the user marked something as higher or lower priority, etc. The interface 502 also executes in conjunction with a system where information can be marked as read or unread. For example, information might be automatically marked as read if another user on the same team 510 as the user has already reviewed the information. The user could also update the read status of the information manually (e.g., unmark the information as read) to provide user flexibility for a global tracking board (illustrated at 610 in FIG. 6). In some implementations, statuses may be updated in different ways, such as to provide information that the user has not already reviewed, to provide information that nobody else on the same team 510 has already reviewed, to provide information that only user X has reviewed, to provide information that a particular team (e.g., Team 2 520) has not already reviewed, etc.

Providing the interface 502 with functionality for the user to input 504 one or more reasons why certain information is relevant or not relevant enables the search engine to provide search results 530-534 that are more targeted in terms of a number of items that might be worth review/consideration. Prior models often output a large number of false negative fields. For example, out of two-hundred thousand bills, the user might only care about one-hundred of the bills, but far too many results may be output from the two-hundred thousand bills via prior models. Since many results are unimportant to the user's search, a system and interface 502 that allows the user to narrow the results based on one or more other users having already reviewed certain results may allow an efficiency of a user and/or team 510/520 to increase. That is, the user and/or the team 510/520 may be able to identify the one-hundred results of interest more quickly from the two-hundred thousand bills in the database.

Result reduction/elimination techniques might have been applicable to an entire organization via prior models. However, complexities associated with individual teams might render organization-wide reduction/elimination techniques impractical. For example, just because the sugar tax team might find a particular result irrelevant to the objectives of the sugar tax team, does not mean that the Alabama team or the regulatory team would necessarily find the same result irrelevant to their respective objectives. Thus, reducing/eliminating certain results at an organization level might not be consistent and/or effective across the organization as a whole. In an example, one organization might have twelve teams of people that are independent from each other, but might want to share search results 530-534 with each other. In another example, twelve different groups of people may be inputting 504 different search terms, but might want to share a same labeling structure with different users/groups while still remaining separate from the different users/groups. Functionalities of the interface 502 can provide users with the flexibility to eliminate items from the user's own search results 530, eliminate other items from the search results 530-534 of the team 510, eliminate items from the search results 534 at the organization level, etc. In some implementations, reduction/elimination techniques may be performed automatically based on various criteria. That is, reduction/elimination procedures may be performed based on more than simply marking or unmarking the search results 530-534 as relevant or not relevant to particular users or teams 510/520.

Algorithmically determining which items in the search results 530-534 certain users would be interested in reviewing can improve the efficiency of the users and/or teams 510/520 in cases where the documents within the database have little additional labeling. In an example, the algorithm may output results 530 that the user is predicted to care about, but also that have not already been reviewed by another user/team 520. In another example, the algorithm may output results 530 for bills that have certain characteristics, but not bills with those characteristics that other users on the same team 510 have already labeled in a certain way. For instance, if a bill was voted down with “no” votes, the bill may be eliminated from the output/results 530, as a bill that is no longer pending might not be important to the user anymore.

Flexibilities associated with the implemented searching techniques allow the user to receive a list of different result structures that are generated on an individualistic basis. Searches 504 may be based on certain topics, a number of results to be displayed, which filters each individual search has programmatically generated based on the legislation, data that is available to the system, etc. Other criteria might include settings 508b selected for the organization based on different organizational criteria. For example, the organization might only care about bills that include certain words, bills that have made it to a certain phase, etc. Metadata may be captured from user activity within the system and applied to the user-specific settings 508a. For example, the metadata may allow the algorithm to more accurately predict/output results 530-534 that specific users might want to review. The system can then compose respective sets of search results 530-534 that include certain criteria, but exclude particular items from the respective sets of search results 530-534 based on other criteria. The filtering 512-516 performed by the system can be based on boolean logic that outputs the different results 530-534 for the different users based on the different criteria. Different system settings 506 may be associated with different sets of filters 512-516. Using different filters 512-516 for different searches 504 can allow the system to generate lists of user-specific results 530-534.

FIG. 6 is a diagram 600 that illustrates tracking boards associated with a plurality of search results 530-534. For the tracking boards 610, information can be stored in a dictionary-like format, where a mapping key can be used to map to values within the tracking boards 610. Each tracking board may be associated with one or more tracking boards. For example, user 1 may be associated with a first tracking board 610a that includes bills 1-Z, user X may be associated with a second tracking board 610b including another list of bills, and user Y may be associated with a third tracking board 610c including yet another list of bills. Each of the users may also have access to a global tracking board 610 associated with the user-specific tracking boards 610a-610c. For each of the one or more tracking boards 610, filtering for different groups/teams can be based on different values. For instance, a user that inputs the search term “soda tax” might be interested in bills that relate to both soft drinks and taxes. Thus, search terms such as soda, soft drinks, soft drink tax, etc., might also be relevant and may be associated with a search terms key. Filters can then be built on top of the search. For example, if the user is only interested in bills that are pending in the year 2022 that include the relevant search terms, a year filter with the number 2022 can be applied on top of the search.

Other filters may be applied to review criteria to filter results that have already been reviewed by other users of the team or organization. Further, results could be filtered based on whether they already include a stance, priority, issue, assignment, etc., where the filters can be combined/applied in any number of different ways (e.g., based on values). The tracking boards 610 can include tracking board settings 606, where the user can define user-specific settings 608a that may be stored on the tracking boards 610 so that, when a particular tracking board 610a is loaded, the user-specific settings 608a can indicate which user is to be presented certain results. The tracking boards settings 606 can also include organizational/team settings 608b. Different filter combinations might be based on metadata associated with the bills. For example, a bill might be filtered based on whether the bill fits certain criteria, whether the bill has already been reviewed by another user, etc. Based on the settings 606 of the tracking boards 610 and the metadata for the bills, the bills can be filtered to show the user a specific combination of information.

In an example where a team includes forty users, it may be inefficient to have each individual enter certain user-specific settings 608a. For instance, if the team is reviewing bills for soda tax, it may be inefficient to have all forty users on the team indicate that they care about bills related to soda tax. Thus, the organization level settings 608b may be used to indicate that bills related to soda tax are important. At the organization level, the bills could be further filtered so that the system only outputs results to users that have not already been reviewed by other users within the organization. If another user in the organization, or a subset of users within the organization, have already reviewed a bill, then that bill may be excluded from the output results.

User activity can be input 604 to the algorithm for user-level settings 608a to determine whether a particular result should be provided to the user. User interface(s) 602 may display the search results 530-534, so that the users can provide input/selections 604 for the tracking boards 610. That is, the users can indicate which bills should be added to their respective tracking boards 610a-610c or added to the global tracking board 610. If the user-level setting 608a is to only display sugar tax legislation if user X or user Y has not already reviewed it, then the activity of user X and user Y can influence the results 530 that are displayed to the user via the interface 602. Thus, a combination of the user settings 608a with the activity of the other users can provide the searching user with a higher probability of receiving/identifying the information that the searching user regards as relevant/important. Types of user activity that might impact the results 530 include an item being viewed, marking an item (e.g., supports or opposes), adding a particular stamp, indicating a certain priority, etc. Results can also be categorized based on an issue (e.g., tax bills). For instance, if a bill is a tax bill, then the bill might be removed from results generated for an agriculture team. Customized fields based on metadata, such as which users have already reviewed certain documents, can also be implemented for the system to adjust the tracking boards 610a-610c based on characteristics associated with the customized fields.

The tracking boards 610a-610c might be generated and indicated in an email based on the settings 606 for the tracking boards 610a-610c. For the user settings 608a, users set their own preferences and, if something changes, the user can adjust their own settings 608a. However, for organizational/team settings 608b, preferences are set at least on a team level, such that the settings 606 of the tracking board might be changed or updated in different ways that manipulate the search results (e.g., associated with a search term). The generated email may be automatically updated for users that rely on the associated tracking board. The email alert may be used for potentially relevant bills that could be important to the organization. The alerts are connected to the user's tracking board 610a so that if a new bill is introduced that matches the user settings 608a for the tracking board, an email alert may be generated for movements on the bills being tracked. Bills can be tracked based on priority, issues that the bills are associated with, etc. The email may be generated/sent to the user based on the user settings 608a (e.g., once per day in the morning). The user settings 608a may also allow the email to be generated/sent if a new bill is introduced that matches the settings.

If a user sets a stance on a bill as “supports” or “opposes”, the user could be implicitly indicating that the bill is important to the organization. Thus, the bill may be pulled into the tracking system (e.g., based on a default setting). In contrast, if the user marks the bill as unimportant, the user is explicitly indicating that the bill is not important to the organization and that the bill can be cleared from the tracking board 610a, which may also occur based on a default setting. The default settings can be used to account for ways in which the activity of the user relates to the tracking board settings 606.

The tracking board 610a can be setup for bills to be cleared if a priority is added to the bill, if an issue is added to the bill, whether the bill has been reviewed/read by one or more other users, etc. Thus, bill tracking can be based on distinct fields. Some teams may setup a review process where a bill goes through multiple tiers of review. For example, a state legislative affairs team might perform a first round of review, a regional director might perform a second round of review, and a legal team might perform a third round of review. Custom fields associated with the tiers may allow users to add distinct data to the bills on their tracking boards 610a-610c, such that the users may follow the bill as they move through the review process based on their unique tracking data.

In another example, a two-tiered review system might include the trackers and the legal team. The trackers may only be permitted to mark the bills based on their own reviewing responsibilities. For instance, the trackers are not regarded as legal experts and, therefore, might not be able to flag a bill as important from a legal standpoint. However, if a particular tracker determines to watch/follow a bill through the legal review process by the legal team, the rest of the trackers on the tracking team may not have to continue following the bill. Thus, the bill may be removed from the tracking board 610a so that the activity is not duplicated by another tracker. The legal team may have a separate tracking board 610c for tracking their own activities. Accordingly, review procedures can be improved based on a system that includes different flexibilities for search results, settings, approvals, different levels and combinations of teams responsible for overlapping amounts of different information, and the like.

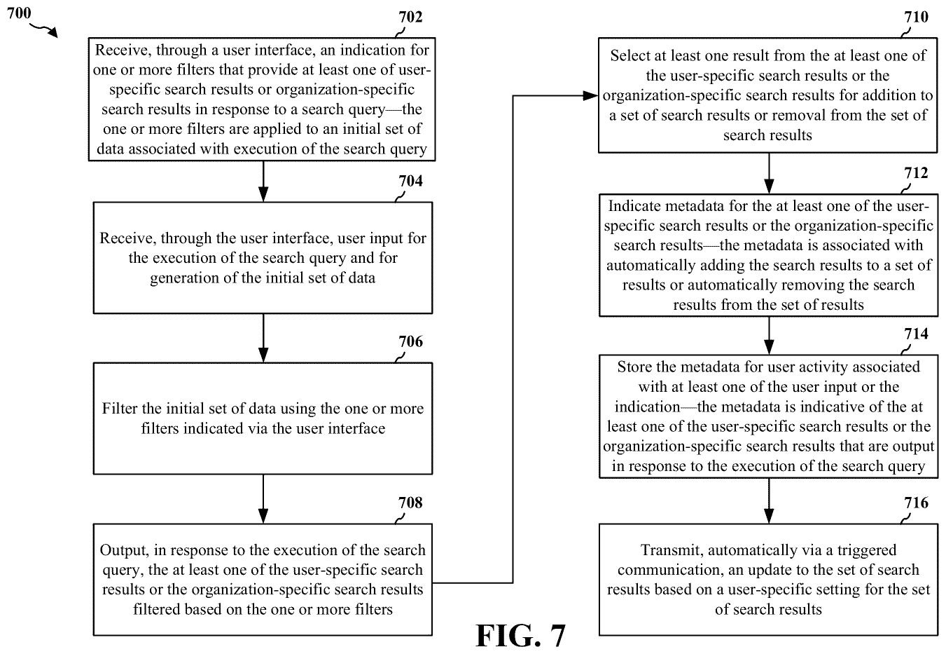

FIG. 7 is a flowchart 700 of a method of outputting user-specific search results. The method may be performed by processing logic that may comprise hardware (e.g., circuitry, dedicated logic, programmable logic, a processor, a processing device, a CPU, a system-on-chip, etc.), software (e.g., instructions running/executing on a processing device), firmware (e.g., microcode), or a combination thereof. In some embodiments, at least a portion of the method may be performed based on aspects of FIGS. 1-6.

With reference to FIG. 7, the method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

The method begins at block 702, where processing logic receives, through a user interface, an indication for one or more filters that provide at least one of user-specific search results or organization-specific search results in response to a search query—the one or more filters are applied to an initial set of data associated with execution of the search query. For example, user-specific settings 508a may be input 504 through the user interface 502 to output user-specific results 530 based on user filter(s) 512. The user filter(s) 512 may be applied to a search executed based on the user input 504.

At block 704, the processing logic receives, through the user interface, user input for the execution of the search query and for generation of the initial set of data. For example, user input 504 to a search field may be received through the user interface 502 to execute the search field and output data for the user filter(s) 512-516.

At block 706, the processing logic filters the initial set of data using the one or more filters indicated via the user interface. For example, the user filter(s) 512-516 filter the data generated based on the search query that is executed via the user input 504 to the search field.

At block 708, the processing logic outputs, in response to the execution of the search query, the at least one of the user-specific search results or the organization-specific search results filtered based on the one or more filters. For example, the search results 530-534 are output from the user filter(s) 512-516 that filter the data generated based on the search query executed via the user input 504 to the search field.

At block 710, the processing logic selects at least one result from the at least one of the user-specific search results or the organization-specific search results for addition to a set of search results or removal from the set of search results. For example, user input 604 to the user interface 602 may be used to select one or more items from the search results 530-534 to be added to, or removed from, the tracking boards 610.

At block 712, the processing logic indicates metadata for the at least one of the user-specific search results or the organization-specific search results—the metadata is associated with automatically adding the search results to a set of results or automatically removing the search results from the set of results. For example, the user input 604 to the user interface 602 may be indicative of a stance for one or more items included in the search results 530-534. The indicated stance may be reflected on the tracking boards 610.

At block 714, the processing logic stores the metadata for user activity associated with at least one of the user input or the indication—the metadata is indicative of the at least one of the user-specific search results or the organization-specific search results that are output in response to the execution of the search query. For example, metadata associated with the search results 530-534 may be generated based on user activity associated with the user-specific settings 508a, user input 504 to the search field, the user filter(s) 512-516, user input/selections 604 for the tracking board(s) 610, etc.

At block 716, the processing logic transmits, automatically via a triggered communication, an update to the set of search results based on a user-specific setting for the set of search results. For example, user input/selections 604 to the user interface 602 that cause the tracking board(s) 610 to be updated may trigger transmission of an email, text message, push notification, etc., indicative of the update.

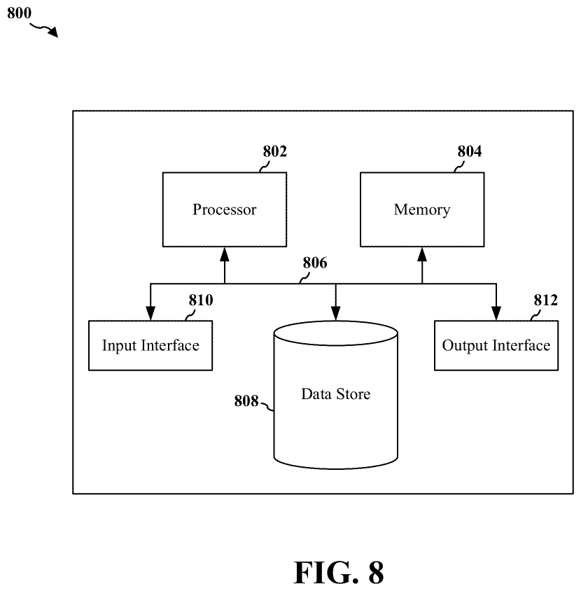

FIG. 8 is a high-level illustration of an exemplary computing device 800 that can be used in accordance with the systems and methodologies disclosed herein. For instance, the computing device 800 may be or include the device 104. The computing device 800 includes at least one processor 802 that executes instructions that are stored in a memory 804. The instructions may be, for instance, instructions for implementing functionality described as being carried out by one or more modules or instructions for implementing one or more of the methods described above. The processor 802 may access the memory 804 by way of a system bus 806.

The computing device 800 additionally includes a data store 808 that is accessible by the processor 802 by way of the system bus 806. The data store 808 may include executable instructions and the like. The computing device 800 also includes an input interface 810 that allows external devices to communicate with the computing device 800. For instance, the input interface 810 may be used to receive instructions from an external computing device, from a user, etc. The computing device 800 also includes an output interface 812 that interfaces the computing device 800 with one or more external devices.

Additionally, while illustrated as a single system, it is to be understood that the computing device 800 may be a distributed system. Thus, for instance, several devices may be in communication by way of a network connection and may collectively perform tasks described as being performed by the computing device 800.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following aspects are illustrative only and may be combined with other aspects or teachings described herein, without limitation.

Example 1 is a method of outputting search results, including: receiving, through a user interface, an indication for one or more filters that provide at least one of user-specific search results or organization-specific search results in response to a search query, the one or more filters applied to an initial set of data associated with execution of the search query; receiving, through the user interface, user input for the execution of the search query and for generation of the initial set of data; filtering the initial set of data using the one or more filters indicated via the user interface; and outputting, in response to the execution of the search query, the at least one of the user-specific search results or the organization-specific search results filtered based on the one or more filters.

Example 2 may be combined with example 1 and further includes selecting at least one result from the at least one of the user-specific search results or the organization-specific search results for addition to a set of search results or removal from the set of search results.

Example 3 may be combined with any of examples 1-2 and includes that the set of search results corresponds to at least one of a user-specific set of search results or a global set of search results for a plurality of users.

Example 4 may be combined with any of examples 1-3 and further includes transmitting, automatically via a triggered communication, an update to the set of search results based on a user-specific setting for the set of search results.

Example 5 may be combined with any of examples 1˜4 and further includes indicating metadata for the at least one of the user-specific search results or the organization-specific search results, the metadata associated with automatically adding the at least one of the user-specific search results or the organization-specific search results to a set of search results or automatically removing the at least one of the user-specific search results or the organization-specific search results from the set of search results.

Example 6 may be combined with any of examples 1-5 and further includes storing metadata for user activity associated with at least one of the user input or the indication, the metadata indicative of the at least one of the user-specific search results or the organization-specific search results that are output in response to the execution of the search query.

Example 7 may be combined with any of examples 1-6 and includes that the at least one of the user-specific search results or the organization-specific search results indicated by the metadata are different from one or more other search results indicated by other metadata associated with other user activity of a second user, the at least one of the user-specific search results or the organization-specific search results and the one or more other search results corresponding to a same search query.

Example 8 may be combined with any of examples 1-7 and includes that the metadata for the user activity corresponds to at least one of viewing the at least one of the user-specific search results or the organization-specific search results, adding or removing the metadata for the at least one of the user-specific search results or the organization-specific search results, indicating a priority for the at least one of the user-specific search results or the organization-specific search results, or adding or removing an issue type for the at least one of the user-specific search results or the organization-specific search results.

Example 9 may be combined with any of examples 1-8 and includes that outputting the at least one of the user-specific search results or the organization-specific search results is further based on filtering the initial set of data for at least one of first results that a user has not already reviewed, second results that a team member of the user has not already reviewed, third results that a particular user has not already reviewed, or fourth results that a different team has not already reviewed.

Example 10 may be combined with any of examples 1-9 and includes that filtering the initial set of data using the one or more filters includes removing, from the initial set of data, at least one of first information associated with a user, second information associated with a team that includes the user, or third information associated with an organization that includes the team.

Example 11 may be combined with any of examples 1-10 and further includes transmitting at least one of the user-specific search results, the organization-specific search results, or a labeling structure for the at least one of the user-specific search results or the organization-specific search results to at least one of a different user or a different team.

Example 12 is an apparatus for wireless communication for implementing a method as in any of examples 1-11.

Example 13 is an apparatus for wireless communication including means for implementing a method as in any of examples 1-11.

Example 14 is a non-transitory computer-readable medium storing computer executable code, the code when executed by at least one processor causes the at least one processor to implement a method as in any of examples 1-11.

What is claimed is:

1. A method of outputting search results, comprising:
receiving, through a user interface, an indication for one or more filters that provide at least one of user-specific search results or organization-specific search results in response to a search query, the one or more filters applied to an initial set of data associated with execution of the search query;
receiving, through the user interface, user input for the execution of the search query and for generation of the initial set of data;
filtering the initial set of data using the one or more filters indicated via the user interface; and
outputting, in response to the execution of the search query, the at least one of the user-specific search results or the organization-specific search results filtered based on the one or more filters.

2. The method of claim 1, further comprising selecting at least one result from the at least one of the user-specific search results or the organization-specific search results for addition to a set of search results or removal from the set of search results.

3. The method of 2, wherein the set of search results corresponds to at least one of a user-specific set of search results or a global set of search results for a plurality of users.

4. The method of claim 2, further comprising transmitting, automatically via a triggered communication, an update to the set of search results based on a user-specific setting for the set of search results.

5. The method of claim 1, further comprising indicating metadata for the at least one of the user-specific search results or the organization-specific search results, the metadata associated with automatically adding the at least one of the user-specific search results or the organization-specific search results to a set of search results or automatically removing the at least one of the user-specific search results or the organization-specific search results from the set of search results.

6. The method of claim 1, further comprising storing metadata for user activity associated with at least one of the user input or the indication, the metadata indicative of the at least one of the user-specific search results or the organization-specific search results that are output in response to the execution of the search query.

7. The method of claim 6, wherein the at least one of the user-specific search results or the organization-specific search results indicated by the metadata are different from one or more other search results indicated by other metadata associated with other user activity of a second user, the at least one of the user-specific search results or the organization-specific search results and the one or more other search results corresponding to a same search query.

8. The method of claim 6, wherein the metadata for the user activity corresponds to at least one of viewing the at least one of the user-specific search results or the organization-specific search results, adding or removing the metadata for the at least one of the user-specific search results or the organization-specific search results, indicating a priority for the at least one of the user-specific search results or the organization-specific search results, or adding or removing an issue type for the at least one of the user-specific search results or the organization-specific search results.

9. The method of claim 1, wherein outputting the at least one of the user-specific search results or the organization-specific search results is further based on filtering the initial set of data for at least one of first results that a user has not already reviewed, second results that a team member of the user has not already reviewed, third results that a particular user has not already reviewed, or fourth results that a different team has not already reviewed.

10. The method of claim 1, wherein filtering the initial set of data using the one or more filters includes removing, from the initial set of data, at least one of first information associated with a user, second information associated with a team that includes the user, or third information associated with an organization that includes the team.

11. The method of claim 1, further comprising transmitting at least one of the user-specific search results, the organization-specific search results, or a labeling structure for the at least one of the user-specific search results or the organization-specific search results to at least one of a different user or a different team.

12. An apparatus for outputting search results, comprising:
a memory; and
at least one processor coupled to the memory and configured to:
receive, through a user interface, an indication for one or more filters that provide at least one of user-specific search results or organization-specific search results in response to a search query, the one or more filters applied to an initial set of data associated with execution of the search query;
receive, through the user interface, user input for the execution of the search query and for generation of the initial set of data;
filter the initial set of data using the one or more filters indicated via the user interface; and
output, in response to the execution of the search query, the at least one of the user-specific search results or the organization-specific search results filtered based on the one or more filters.

13. The apparatus of claim 12, wherein the at least one processor is further configured to select at least one result from the at least one of the user-specific search results or the organization-specific search results for addition to a set of search results or removal from the set of search results.

14. The apparatus of claim 12, wherein the at least one processor is further configured to indicate metadata for the at least one of the user-specific search results or the organization-specific search results, the metadata associated with automatically adding the at least one of the user-specific search results or the organization-specific search results to a set of search results or automatically removing the at least one of the user-specific search results or the organization-specific search results from the set of search results.

15. The apparatus of claim 12, wherein the at least one processor is further configured to store metadata for user activity associated with at least one of the user input or the indication, the metadata indicative of the at least one of the user-specific search results or the organization-specific search results that are output in response to the execution of the search query.

16. The apparatus of claim 15, wherein the at least one of the user-specific search results or the organization-specific search results indicated by the metadata are different from one or more other search results indicated by other metadata associated with other user activity of a second user, the at least one of the user-specific search results or the organization-specific search results and the one or more other search results corresponding to a same search query.

17. The apparatus of claim 15, wherein the metadata for the user activity corresponds to at least one of viewing the at least one of the user-specific search results or the organization-specific search results, adding or removing the metadata for the at least one of the user-specific search results or the organization-specific search results, indicating a priority for the at least one of the user-specific search results or the organization-specific search results, or adding or removing an issue type for the at least one of the user-specific search results or the organization-specific search results.

18. The apparatus of claim 12, wherein to output the at least one of the user-specific search results or the organization-specific search results the at least one processor is further configured to filter the initial set of data for at least one of first results that a user has not already reviewed, second results that a team member of the user has not already reviewed, third results that a particular user has not already reviewed, or fourth results that a different team has not already reviewed.

19. The apparatus of claim 12, wherein to filter the initial set of data using the one or more filters the at least one processor is further configured to remove, from the initial set of data, at least one of first information associated with a user, second information associated with a team that includes the user, or third information associated with an organization that includes the team.

20. A non-transitory computer-readable medium storing computer executable code, the code when executed by a processor causes the processor to:
receive, through a user interface, an indication for one or more filters that provide at least one of user-specific search results or organization-specific search results in response to a search query, the one or more filters applied to an initial set of data associated with execution of the search query;
receive, through the user interface, user input for the execution of the search query and for generation of the initial set of data;
filter the initial set of data using the one or more filters indicated via the user interface; and
output, in response to the execution of the search query, the at least one of the user-specific search results or the organization-specific search results filtered based on the one or more filters.
